(19) United States
(12) Patent Application Publication
(10) Pub. No.: US 2024/0300502 A1
(43) Pub. Date: Sep. 12, 2024

(54) METHOD AND APPARATUS FOR PERFORMING FAIL SAFE IN CASE OF VEHICLE COMPONENT FAILURE

(71) Applicants: Hyundai Motor Company, Seoul (KR); Kia Corporation, Seoul (KR)

(72) Inventors: Ki Ho Lee, Yongin-si (KR); Su Min Choi, Suwon-si (KR); In Mook Kim, Seoul (KR); Kyung Soo Ha, Hwaseong-si (KR); Sun Woo Kang, Suwon-si (KR)

(21) Appl. No.: 18/418,619

(22) Filed: Jan. 22, 2024

(30) Foreign Application Priority Data
Mar. 7, 2023 (KR) 10-2023-0029705

(51) Int. Cl. B60W 50/029; B60W 10/04; B60W 10/18; B60W 10/20; B60W 30/06

(52) U.S. Cl. CPC B60W 50/029; B60W 10/04; B60W 10/18; B60W 10/20; B60W 30/06; B60W 2050/0292; B60W 2420/403; B60W 2420/408; B60W 2420/54; B60W 2520/04; B60W 2556/45

(57) ABSTRACT

An embodiment method for performing a fail-safe function using an apparatus for performing the fail-safe function includes determining whether there is a replacement component to perform a function of a failed component in response to failure of one or more components installed in a vehicle, determining an operation mode of a remote smart parking assist (RSPA) controller based on a result of determining whether there is the replacement component, and operating the RSPA controller or a cooperative controller based on the operation mode.

### CROSS-REFERENCE TO RELATED APPLICATIONS

This application claims the benefit of Korean Patent Application No. 10-2023-0029705, filed on Mar. 7, 2023, which application is hereby incorporated herein by reference.

### TECHNICAL FIELD

The present disclosure relates to a method and apparatus for performing a fail-safe function in the case of vehicle component failure.

### BACKGROUND

The content described hereinbelow merely provides background information on embodiments of the present disclosure and does not constitute the prior art.

A remote smart parking assist (RSPA) is a system that causes a vehicle itself to be safely parked in a designated location when a driver sends a signal using a smart key outside the vehicle. The RSPA is a state-of-the-art parking convenience system that assists the vehicle in parking or exiting by automatically controlling the steering, vehicle speed, shifting, and starting functions of the vehicle in a state where a driver enters or exits. The core of the RSPA is to automatically perform a series of operations that are manually performed by the driver in an existing parking method. A highway driving pilot (HDP) is a conditional autonomous driving function that maintains a lane and a distance from a vehicle in front while allowing a driver to hand off when the vehicle drives on a main line of a highway or a motorway. The HDP performs emergency driving when an imminent collision risk occurs. If a malfunction or critical situation occurs, it is requested to transfer the control right to the driver. At this time, unless the control right is transferred to the driver, driving for minimizing the risk is performed. A fail-safe function corresponds to a function that activates another safety device to prevent a critical accident or danger when a defect or failure occurs in a portion or component of a vehicle, thus automatically guaranteeing safety.

In the case that a failure occurs in a safety-related component in the vehicle when the vehicle is remotely parked by the RSPA, it may be difficult to transfer the control right to the driver and then take safety measures. In order to ensure safety in performing the HDP, it is necessary to preferentially improve safety in the RSPA. In addition, it is necessary to enhance the stability of the RSPA using a redundancy controller and normally operate the RSPA.

### SUMMARY

The present disclosure relates to a method and apparatus for performing a fail-safe function in the case of vehicle component failure. Particular embodiments relate to a method and apparatus for performing a fail-safe function using a remote smart parking assist (RSPA) controller or a cooperative controller according to a severity of failure when a vehicle component failure occurs.

According to embodiments of the present disclosure, a method for performing a fail-safe function includes determining whether there is a replacement component to perform a function of a failed component in response to failure of one or more components installed in a vehicle, determining an operation mode of a remote smart parking assist (RSPA) controller based on a result of determining whether there is the replacement component, and operating the RSPA controller or a cooperative controller based on the operation mode.

According to embodiments of the present disclosure, an apparatus for performing a fail-safe function includes one or more processors and a storage device storing a program to be executed by the one or more and processors, to the program including instructions for determining whether there is a replacement component to perform a function of a failed component in response to failure of one or more components installed in a vehicle fail, determining an operation mode of a remote smart parking assist (RSPA) controller based on a result of determining whether there is the replacement component and operating the RSPA controller or a cooperative controller based on the operation mode.

### BRIEF DESCRIPTION OF THE DRAWINGS

FIG. 1 is a diagram illustrating a control device mounted on a vehicle according to an embodiment of the present disclosure.

FIG. 2 is a diagram illustrating a system for performing a fail-safe function in the case of a vehicle component failure according to an embodiment of the present disclosure.

FIG. 3 is a diagram illustrating a method for performing a fail-safe function according to a severity of failure before or during the operation of an RSPA controller according to an embodiment of the present disclosure.

FIG. 4 is a diagram illustrating a method in which the RSPA controller performs a fail-safe function and a method in which a cooperative controller performs a fail-safe function according to an embodiment of the present disclosure.

FIGS. 5A and 5B are diagrams illustrating a vehicle control process and a comparison table when failure occurs in a vehicle component before the RSPA controller operates according to an embodiment of the present disclosure.

FIGS. 6A and 6B are diagrams illustrating a vehicle control process and a comparison table when a driver is in a vehicle and failure occurs in a vehicle component according to an embodiment of the present disclosure.

FIGS. 7A and 7B are diagrams illustrating a vehicle control process and a comparison table in the case of a vehicle component failure in a state where a driver is not in the vehicle and the vehicle is remotely controlled according to an embodiment of the present disclosure.

FIG. 8 is a diagram illustrating a method for performing a fail-safe function in the case of a vehicle component failure according to an embodiment of the present disclosure.

### DETAILED DESCRIPTION OF ILLUSTRATIVE EMBODIMENTS

According to embodiments of the present disclosure, it is possible to provide a method and apparatus which can perform a fail-safe function according to a severity of failure, when failure occurs in a safety-related component of a vehicle.

Further, according to embodiments of the present disclosure, it is possible to provide a method and apparatus which can perform a fail-safe function using an RSPA controller, when failure occurs in a safety-related component of a vehicle.

Further, according to embodiments of the present disclosure, it is possible to provide a method and apparatus which can perform a fail-safe function using a cooperative controller, when failure occurs in a safety-related component of a vehicle.

Further, according to embodiments of the present disclosure, it is possible to provide a method and apparatus which can enhance the stability of an RSPA and increase a driver's convenience.

The effects achievable by embodiments of the present disclosure are not limited to the above-mentioned effects, and other effects which are not mentioned will be clearly understood by those skilled in the art from the following description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention and is not intended to represent the only embodiments in which the present invention may be practiced.

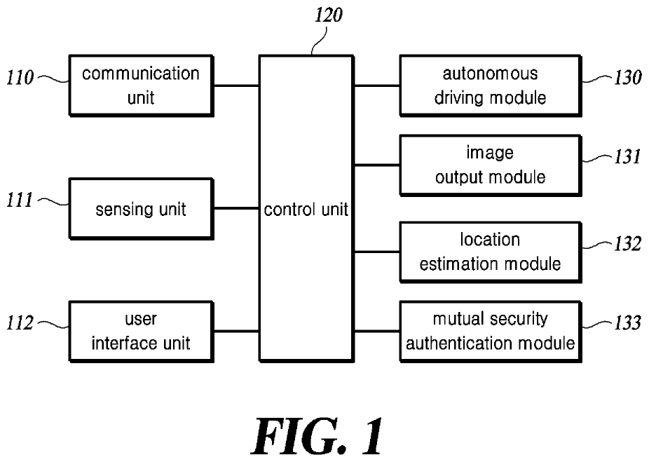

FIG. 1 is a diagram illustrating a control device mounted on a vehicle according to an embodiment of the present disclosure.

Referring to FIG. 1, an autonomous vehicle may include a communication unit 110, a sensing unit 111, a user interface unit 112, a control unit 120, an autonomous driving module 130, an image output module 131, a location estimation module 132, and a mutual security authentication module 133. The communication unit 110 may transceive information through a communication network between autonomous vehicles and between an autonomous vehicle and other objects. The communication unit 110 may transceive information between the autonomous vehicles and between the autonomous vehicle and other objects through at least one communication method among LAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), and LTE-A (Long Term Evolution-Advanced).

Further, the communication unit 110 may perform near-field communication between the autonomous vehicles and between the autonomous vehicle and other objects. Since the autonomous vehicles drive while maintaining a short distance therebetween, the communication unit 110 may transceive information between the autonomous vehicles and between the autonomous vehicle and other objects through the near-field communication. In this case, the communication unit 110 may transceive various pieces of information between the autonomous vehicles and between the autonomous vehicle and other objects through Bluetooth, RFID (Radio Frequency Identification), Infrared Data Association (IrDA), UWB (Ultra WideBand), ZigBee, NFC (Near Field Communication), Wi-Fi (Wireless-Fidelity), Wi-Fi Direct, Wireless USB (Wireless Universal Serial Bus), etc.

The sensing unit 111 may include a radar, a camera, an ultrasonic sensor, a lidar, etc. The sensing unit 111 may detect the speed and location of a surrounding autonomous vehicle and the speed and location of a surrounding object. The sensing unit 111 may detect all objects including obstacles, people, animals, toll gates, and breakwaters as well as the autonomous vehicle. The user interface unit 112 may provide a user interface to a driver. The user interface unit 112 may receive information from the driver and then input the information into the control unit 120 or output a result according to an operation. For example, the driver may input information on a surrounding autonomous vehicle and information on a surrounding object into the user interface unit 112. The user interface unit 112 may input information on the surrounding autonomous vehicle and information on the surrounding object into the control unit 120. The control unit 120 may transmit a control command to the autonomous driving module 130 using information on the surrounding autonomous vehicle and information on the surrounding object.

The control unit 120 may control the autonomous driving module 130, the image output module 131, the location estimation module 132, and the mutual security authentication module 133 according to information inputted from the communication unit 110, the sensing unit 111, and the user interface unit 112. The control unit 120 may include a trained learning model. The learning model may correspond to a deep learning based model or a support vector machine model. The control unit 120 may further include a learning unit (not shown) for pre-training the learning model. The learning unit may pre-train the learning model using supervised learning, unsupervised learning, semi-supervised learning, and/or reinforcement learning. Here, a specific method in which the learning unit trains the learning model based on learning data is common in this field, so a detailed description thereof will be omitted. The control unit 120 may include a remote smart parking assist (RSPA) controller and a cooperative controller. The RSPA controller may transmit control commands to a braking device, a steering device, a driving device, a communication device, and a transmission device. The cooperative controller may transmit control commands to the braking device, the communication device, and the steering device. The cooperative controller may include a braking controller, a steering controller, a driving controller, and a transmission controller.

The autonomous driving module 130 may change or maintain the speed and direction of the vehicle in response to the control command of the control unit 120. The autonomous driving module 130 may include the braking device and the steering device. The autonomous driving module 130 may change or maintain the speed and direction of the vehicle using the braking device and the steering device. The image output module 131 may output the image of a surrounding vehicle, a surrounding obstacle, and a surrounding building to the driver in response to the control command of the control unit 120. The location estimation module 132 may estimate the location of a surrounding object using a trilateration technique in response to the control command of the control unit 120. The mutual security authentication module 133 may perform authentication using an identifier (ID) between surrounding vehicles and objects in response to the control command of the control unit 120. This authentication may be performed through UWB. The autonomous vehicle may defend against a spoofing attack by an attacker through such an authentication.

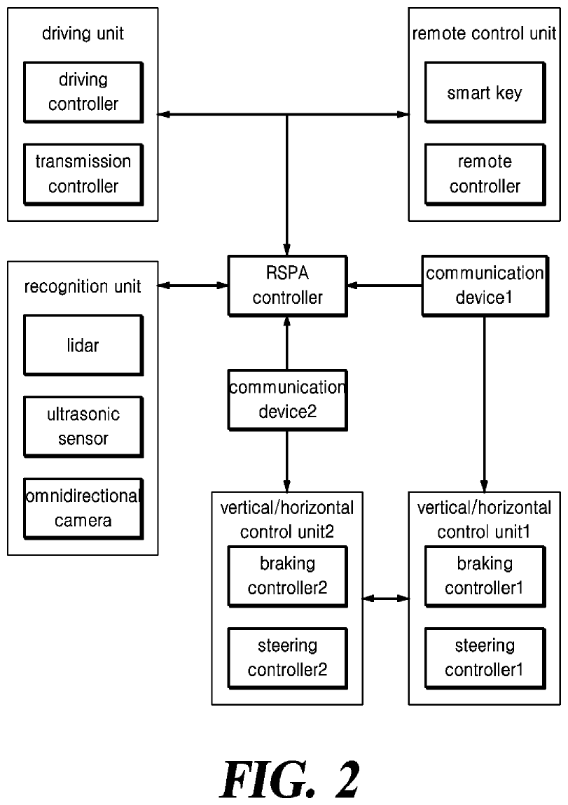

FIG. 2 is a diagram illustrating a system for performing a fail-safe function in the case of a vehicle component failure according to an embodiment of the present disclosure.

Referring to FIG. 2, the RSPA controller may transmit control commands to a driving unit, a recognition unit, a remote control unit, a vertical/horizontal control unit 1, and a vertical/horizontal control unit 2 of the vehicle. The driving unit may include a driving controller and a transmission controller. The driving controller may control the driving device to drive various devices in the vehicle. The transmission controller may control the transmission device to change the speed of the vehicle. The recognition unit may include a lidar, an ultrasonic sensor, and an omnidirectional camera. The remote control unit may include a remote controller and a smart key. The vertical/horizontal control unit 1 may include a braking controller 1 and a steering controller 1. The braking controller 1 may control the braking device to stop the vehicle. The steering controller 1 may control the steering device to change a direction in which the vehicle moves. The vertical/horizontal control unit 2 may include a braking controller 2 and a steering controller 2. The braking controller 2 may perform a replaceable function when the braking controller 1 fails. The steering controller 2 may perform a replaceable function when the steering controller 1 fails. The RSPA controller may transmit the control command to the vertical/horizontal controller 1 using the communication device 1. The RSPA controller may transmit the control command to the vertical/horizontal controller 2 using the communication device 2.

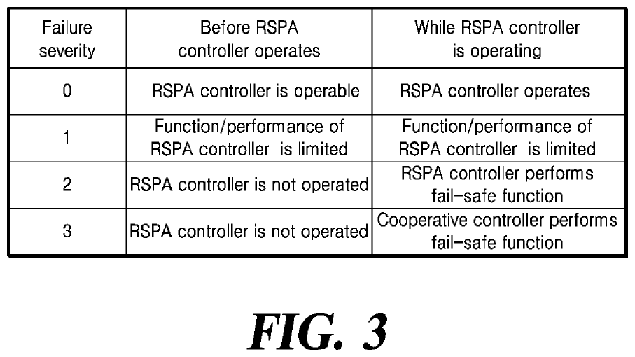

FIG. 3 is a diagram illustrating a method for performing a fail-safe function according to a severity of failure before or during the operation of the RSPA controller according to an embodiment of the present disclosure. In a state where the RSPA controller is operated, the driving device, the braking device, the transmission device, and the steering device for parking the vehicle may be operated in response to the control command of the RSPA controller. When the RSPA controller fails, the RSPA controller may be operated with limited functions or performance or may not be operated depending on the severity of the failure. When the RSPA controller is not operated due to the failure of the RSPA controller, the driving device, the transmission device, the braking device, and the steering device may be operated in response to the control command of the cooperative controller.

Referring to FIG. 3, a case in which the failure severity is 0 and the RSPA controller is not operated yet may correspond to a state where the RSPA controller is operable. When the failure severity is 0 and the RSPA controller is in operation, the RSPA controller may continue operating. When the failure severity is 1 and the RSPA controller is not operated yet, the RSPA controller may be operated with limited functions or performance. When the failure severity is 1 and the RSPA controller is in operation, the RSPA controller may be operated with limited functions or performance. If the RSPA controller is operated with limited functions or performance, the RSPA controller may transmit limited control commands to the driving device, the braking device, the transmission device, and the steering device. For instance, assuming that the RSPA controller is operated with limited functions or performance, the RSPA controller may transmit the control command to the transmission device so as to increase or decrease speed only up to a certain speed. For instance, assuming that the RSPA controller is operated with limited functions or performance, the RSPA controller may transmit the control command to the steering device to change a direction within a certain range.

When the failure severity is 2 and the RSPA controller is not operated yet, the RSPA controller may not be operated. When the failure severity is 2 and the RSPA controller is in operation, the RSPA controller may perform the fail-safe function. When the failure severity is 3 and the RSPA controller is not operated yet, the RSPA controller may not be operated. When the failure severity is 3 and the RSPA controller is in operation, the RSPA controller may not be operated and the cooperative controller may perform the fail-safe function.

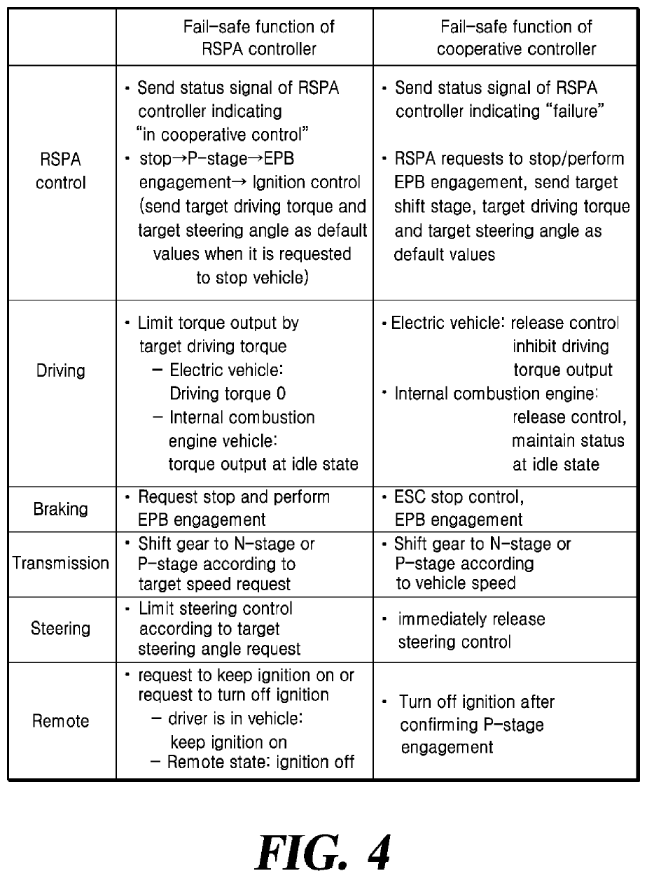

FIG. 4 is a diagram illustrating a method in which the RSPA controller performs the fail-safe function and a method in which the cooperative controller performs the fail-safe function according to an embodiment of the present disclosure. When a failure situation in which it is difficult for the RSPA controller to operate occurs, the RSPA controller may perform the fail-safe function or the cooperative controller may perform the fail-safe function depending on the failure severity. When the RSPA controller may not perform the fail-safe function, the cooperative controller may perform the fail-safe function.

Referring to FIG. 4, the RSPA controller may transmit the control command to the driving device, the braking device, the transmission device, the steering device, and the remote device to perform the fail-safe function. When the RSPA controller performs the fail-safe function, the RSPA controller may send a status signal indicating “in cooperative control” to another device. First, the RSPA controller may request a stop. Second, the RSPA controller may request that a gear of the vehicle is shifted to a parking (P)-stage. Third, the RSPA controller may request to perform electronic parking brake (EPB) engagement. Fourth, the RSPA controller may request to keep the ignition on or turn the ignition off. The RSPA controller may send a target driving torque and a target steering angle as default values to another device when it is requested to stop the vehicle.

When the RSPA controller performs the fail-safe function, the RSPA controller may request the driving device to reach the target driving torque. Thus, torque output may be limited. In the case of an electric vehicle, the RSPA controller may set the target driving torque to zero. In the case of an internal combustion engine vehicle, the RSPA controller may set the target driving torque to an ideal level of torque.

When the RSPA controller performs the fail-safe function, the RSPA controller may request the braking device to stop the vehicle and perform the EPB engagement. When the RSPA controller performs the fail-safe function, the RSPA controller may request the transmission device to reach a target speed. Thus, the vehicle speed may be limited. The gear of the vehicle may be shifted to a neutral (N)-stage or a P-stage. When the RSPA controller performs the fail-safe function, the RSPA controller may request the steering device to reach a target steering angle. Thus, the steering angle of the vehicle may be limited. When the RSPA controller performs the fail-safe function, the RSPA controller may request the remote device to keep the ignition of the vehicle on or turn the ignition off. When a driver is in the vehicle, the ignition of the vehicle may be maintained in the ON state. When a driver is not in the vehicle and remotely controls the vehicle, the ignition of the vehicle may be turned off.

When the cooperative controller performs the fail-safe function, the RSPA controller may send a status signal indicating “failure” to another device. The RSPA controller may request to stop the vehicle and perform the EPB engagement. The RSPA controller may send the target speed, the target driving torque, and the target steering angle as default values to another device.

When the cooperative controller performs the fail-safe function, the driving controller may release the control of the driving device. In the case of an electric vehicle, the driving controller may inhibit the driving torque output. In the case of an internal combustion engine vehicle, the driving controller may maintain the driving torque at an ideal level of torque.

When the cooperative controller performs the fail-safe function, the braking controller may transmit the control command to the braking device so that an electric safety control (ESC) stops the vehicle. Simultaneously, the braking controller may request the braking device to perform the EPB engagement. When the cooperative controller performs the fail-safe function, the transmission controller may request the transmission device to shift the gear of the vehicle to the N-stage or the P-stage depending on the speed of the vehicle. When the cooperative controller performs the fail-safe function, the steering controller may request the steering device to immediately release the steering control. When the cooperative controller performs the fail-safe function, the remote controller confirms that the gear is engaged in the P-stage and may request the remote device to turn off the ignition of the vehicle.

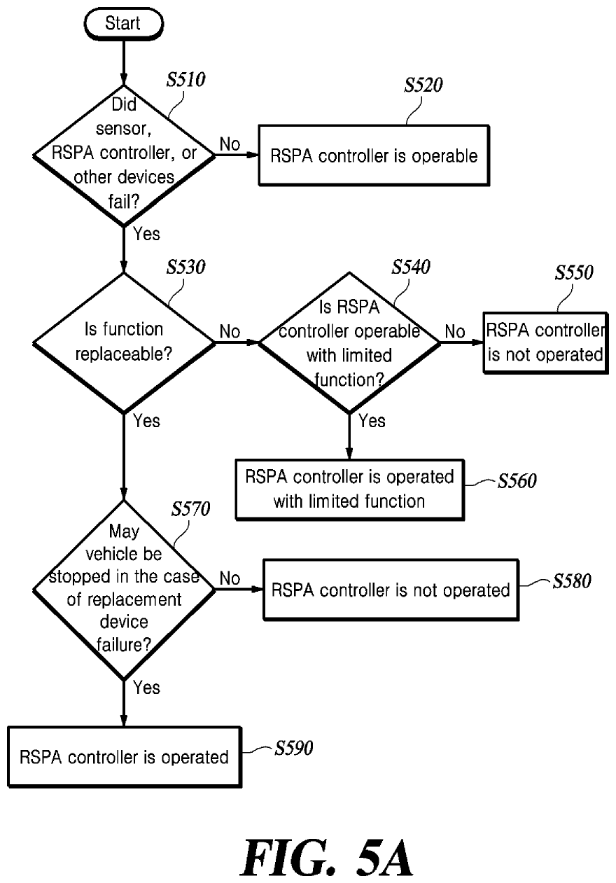

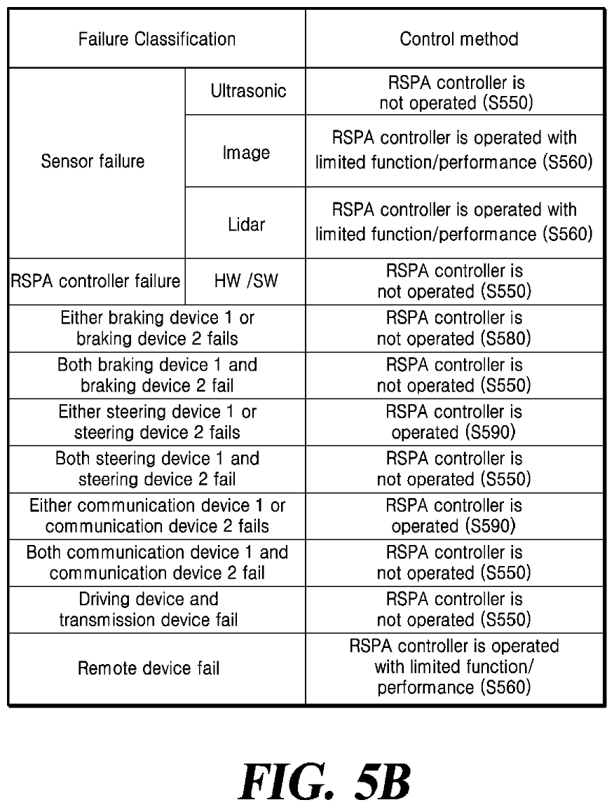

FIGS. 5A and 5B are diagrams illustrating a vehicle control process and a comparison table, when failure occurs in a vehicle component before the RSPA controller operates, according to an embodiment of the present disclosure.

Referring to FIG. 5A, it may be determined whether a sensor, the RSPA controller, or other devices fail (S510). When the sensor, the RSPA controller, or the other devices do not fail (S510—NO), the RSPA controller may be operable (S520). When the sensor, the RSPA controller, or the other devices fail (S510—YES), it may be determined whether the function of the failed device may be replaced with another one (S530). When the function of the failed device may not be replaced (S530—NO), it may be determined whether the RSPA controller is operable with limited functions (S540). When the RSPA controller is not operable with limited functions (S540—NO), the RSPA controller may not be operated (S550). The step (S550) in which the RSPA controller is not operated may be performed when an ultrasonic device of FIG. 5B fails, the RSPA controller of FIG. 5B fails, both the braking device 1 and the braking device 2 of FIG. 5B fail, both the steering device 1 and the steering device 2 of FIG. 5B fail, both the communication device 1 and the communication device 2 of FIG. 5B fail, the driving device of FIG. 5B fails, or the transmission device of FIG. 5B fails.

When the RSPA controller is operable with limited functions (S540—YES), the RSPA controller may be operated with limited functions (S560). The step (S560) in which the RSPA controller is operated with limited functions may be performed when an imaging device of FIG. 5B fails, the lidar of FIG. 5B fails, or the remote device of FIG. 5B fails. For instance, when the imaging device fails, the RSPA controller may be operated in a state where an image-related function such as a parking-line based control function is limited. When the lidar fails, the RSPA controller may be operated in a state where a lidar-related function such as a path based control function is limited.

When the function of the failed device is replaceable (S530—YES), it may be determined whether the vehicle may be stopped in the case of the failure of a replacement device (S570). When the replacement device fails and the vehicle may not be stopped (S570—NO), the RSPA controller may not be operated (S580). The step (S580) in which the RSPA controller is not operated may be performed when either the braking device 1 or the braking device 2 of FIG. 5B fails. When the replacement device fails but the vehicle may be stopped (S570—YES), the RSPA controller may be operated (S590). The step (S590) in which the RSPA controller is operated may be performed when either the braking device 1 or the braking device 2 of FIG. 5B fails or either the communication device 1 or the communication device 2 of FIG. 5B fails.

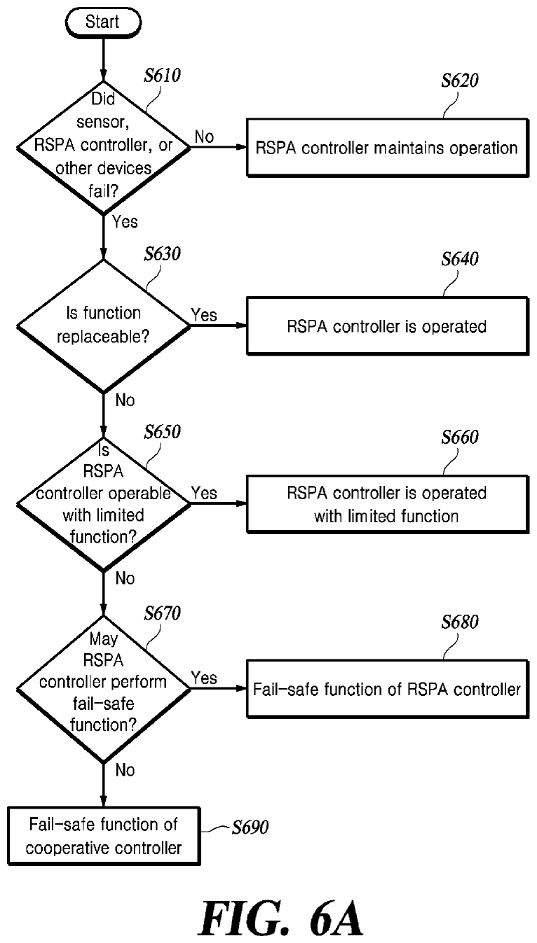

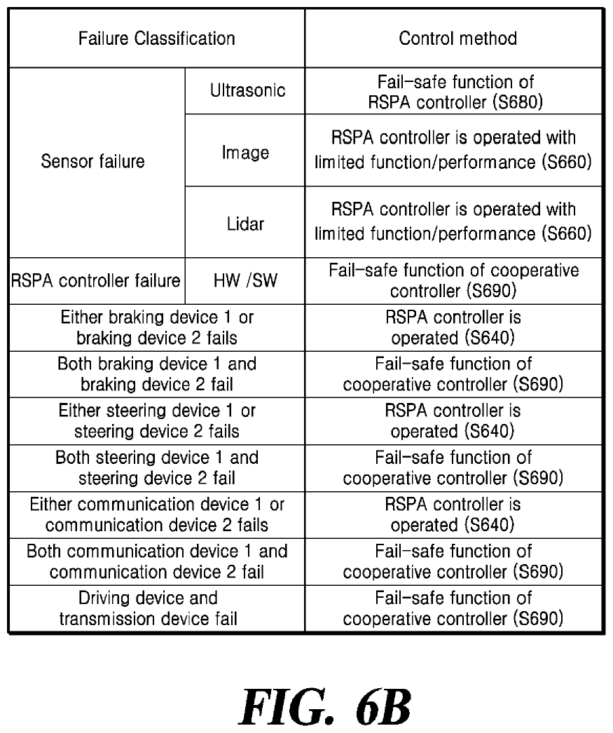

FIGS. 6A and 6B are diagrams illustrating a vehicle control process and a comparison table, when a driver is in the vehicle and failure occurs in the vehicle component, according to an embodiment of the present disclosure.

Referring to FIG. 6A, it may be determined whether the sensor, the RSPA controller, or the other devices fail (S610). When the sensor, the RSPA controller, or the other devices do not fail (S610—NO), the RSPA controller may maintain the operation (S620). When the sensor, the RSPA controller, or the other devices fail (S610—YES), it may be determined whether the function of the failed device is replaceable (S630). When the function of the failed device is replaceable (S630—YES), the RSPA controller may be operated (S640). The step (S640) in which the RSPA controller is operated may be performed when either the braking device 1 or the braking device 2 of FIG. 6B fails, either the steering device 1 or the steering device 2 of FIG. 6B fails, or either the communication device 1 or the communication device 2 of FIG. 6B fails. For instance, when either the braking device 1 or the braking device 2 fails, the RSPA controller may transmit the control command to a normal braking device. When either the steering device 1 or the steering device 2 fails, the RSPA controller may transmit the control command to a normal steering device. When either the communication device 1 or the communication device 2 fails, the RSPA controller may transmit the control command to a normal communication device.

When the function of the failed device is not replaceable (S630—NO), it may be determined whether the RSPA controller is operable with limited functions (S650). When the RSPA controller is operable with limited functions (S650—YES), the RSPA controller may be operated with limited functions (S660). The step (S660) in which the RSPA controller is operated with limited functions may be performed when the imaging device of FIG. 6B fails or the lidar of FIG. 6B fails.

When the RSPA controller is not operable with limited functions (S650—NO), it may be determined whether the RSPA controller may perform the fail-safe function (S670). When the RSPA controller may perform the fail-safe function (S670—YES), the RSPA controller may perform the fail-safe function (S680). The step (S680) in which the RSPA controller performs the fail-safe function may be performed when the ultrasonic device of FIG. 6B fails. When the RSPA controller may not perform the fail-safe function (S670—NO), the cooperative controller may perform the fail-safe function (S690). The step (S690) in which the cooperative controller performs the fail-safe function may be performed when the RSPA controller of FIG. 6B fails, both the braking device 1 and the braking device 2 of FIG. 6B fail, both the steering device 1 and the steering device 2 of FIG. 6B fail, both the communication device 1 and the communication device 2 of FIG. 6B fail, the driving device of FIG. 6B fails, or the transmission device of FIG. 6B fails.

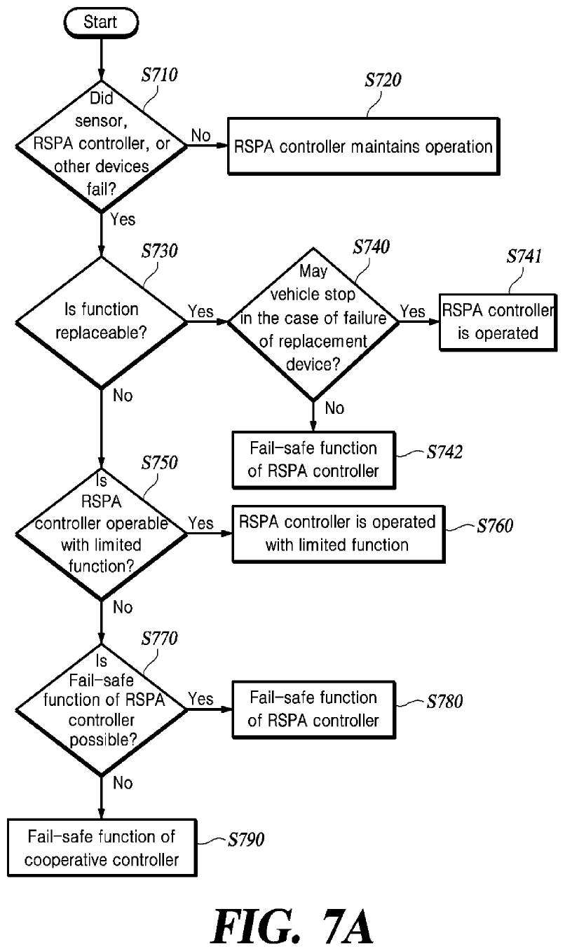

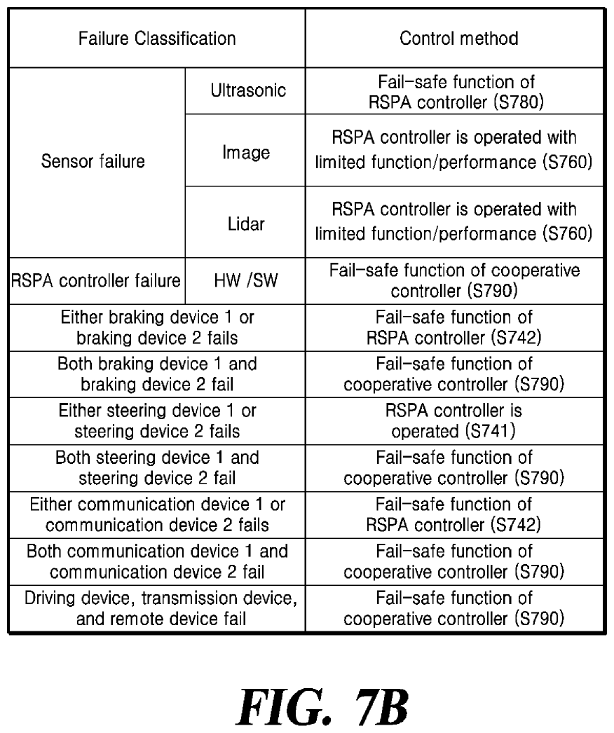

FIGS. 7A and 7B are diagrams illustrating a vehicle control process and a comparison table in the case of a vehicle component failure in a state where a driver is not in the vehicle and the vehicle is remotely controlled according to an embodiment of the present disclosure.

Referring to FIG. 7A, it may be determined whether the sensor, the RSPA controller, or the other devices fail (S710). When the sensor, the RSPA controller, or the other devices do not fail (S710—NO), the RSPA controller may maintain the operation (S720). When the sensor, the RSPA controller, or the other devices fail (S710—YES), it may be determined whether the function of the failed device is replaceable with another one (S730). When the function of the failed device is replaceable (S730—YES), it may be determined whether the vehicle may be stopped in the case of the failure of the replacement device (S740). When the replacement device fails and the vehicle may stop (S740—YES), the RSPA controller may be operated (S741). The step (S741) in which the RSPA controller is operated may be performed when either the steering device 1 or the steering device 2 of FIG. 7B fails. For instance, when either the steering device 1 or the steering device 2 of FIG. 7B fails, the RSPA controller may transmit the control command to a normal steering device.

When the replacement device fails and the vehicle may not be stopped (S740—NO), the RSPA controller may perform the fail-safe function (S742). The step (S742) in which the RSPA controller performs the fail-safe function may be performed when either the braking device 1 or the braking device 2 of FIG. 7B fails or either the communication device 1 or the communication device 2 of FIG. 7B fails. For instance, when either the braking device 1 or the braking device 2 fails, the RSPA controller may transmit the control command to a normal braking device to perform the fail-safe function. When either the communication device 1 or the communication device 2 fails, the RSPA controller may transmit the control command to a normal communication device to perform the fail-safe function.

When the function of the failed device is not replaceable with another one (S730—NO), it may be determined whether the RSPA controller is operable with limited functions (S750). When the RSPA controller is operable with limited functions (S750—YES), the RSPA controller may be operated with limited functions (S760). The step (S760) in which the RSPA controller is operated with limited functions may be performed when the imaging device of FIG. 7B fails or the lidar of FIG. 7B fails.

When the RSPA controller is not operable with limited functions (S750—NO), it may be determined whether the RSPA controller may perform the fail-safe function (S770). When the RSPA controller may perform the fail-safe function (S770—YES), the RSPA controller performs the fail-safe function (S780). The step (S780) in which the RSPA controller performs the fail-safe function may be performed when the ultrasonic device of FIG. 7B fails.

When the RSPA controller may not perform the fail-safe function (S770—NO), the cooperative controller may perform the fail-safe function (S790). The step in which the cooperative controller performs the fail-safe function may be performed when the RSPA controller of FIG. 7B fails, both the braking device 1 and the braking device 2 of FIG. 7B fail, both the steering device 1 and the steering device 2 of FIG. 7B fail, both the communication device 1 and the communication device 2 of FIG. 7B fail, the driving device of FIG. 7B fails, the transmission device of FIG. 7B fails, or the remote device of FIG. 7B fails.

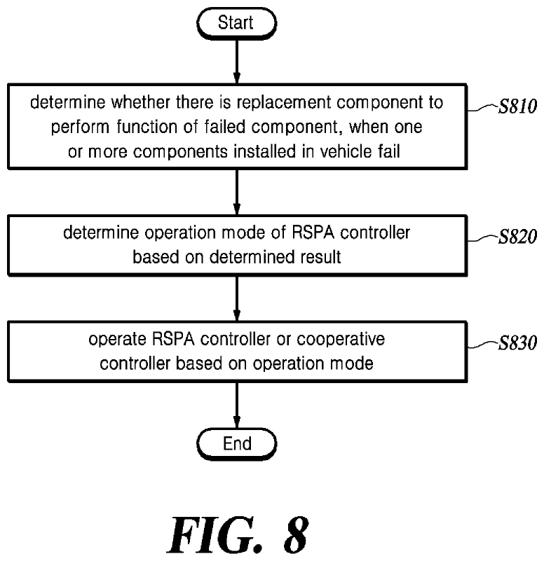

FIG. 8 is a diagram illustrating a method for performing a fail-safe function in the case of a vehicle component failure according to an embodiment of the present disclosure.

Referring to FIG. 8, when one or more components installed in the vehicle fail, the apparatus for performing the fail-safe function may determine whether there is a replacement component to perform the function of the failed component (S810). One or more components installed in the vehicle may include at least one among the RSPA controller, one or more braking devices, one or more steering devices, one or more communication devices, the ultrasonic device, the imaging device, the lidar, the driving device, the transmission device, and the remote device.

The apparatus for performing the fail-safe function may determine the operation mode of the RSPA controller based on the determined result (S820). When the RSPA controller is not operated yet and there is no replacement component to perform the function of the failed component, the step of determining the operation mode of the RSPA controller may include a step of determining the operation mode of the RSPA controller based on whether the RSPA controller is operable with limited functions. When the RSPA controller is not operated yet and the replacement component is present to perform the function of the failed component, the step of determining the operation mode of the RSPA controller may include a step of determining whether the vehicle may be stopped in the case of the failure of the replacement component and a step of determining the operation mode of the RSPA controller based on the result of determining whether the vehicle may be stopped.

When the driver is in the vehicle, the RSPA controller is in operation, and there is no replacement component to perform the function of the failed component, the step of determining the operation mode of the RSPA controller may include a step of determining the operation mode of the RSPA controller based on whether the RSPA controller may be operated with limited functions. When the RSPA controller is in operation and the replacement component is present to perform the function of the failed component, the operation mode of the RSPA controller may be determined through a method where the RSPA controller controls the replacement component. When the RSPA controller may not be operated with limited functions, the step of determining the operation mode of the RSPA controller may include a step of determining the operation mode of the RSPA controller and the operation mode of the cooperative controller based on whether the RSPA controller may perform the fail-safe function. When the RSPA controller may be operated with limited functions, the operation mode of the RSPA controller may be determined such that the RSPA controller is operated with limited functions. The cooperative controller may include at least one among the braking controller, the steering controller, the communication controller, the driving controller, the transmission controller, and the remote controller.

When the driver is not in the vehicle, the RSPA controller is in operation, and the replacement component is present to perform the function of the failed component, the step of determining the operation mode of the RSPA controller may include a step of determining whether the vehicle may be stopped in the case of the failure of the replacement component, and a step of determining the operation mode of the RSPA controller based on the result of determining whether the vehicle may be stopped. When the driver is not in the vehicle, the RSPA controller is in operation, and there is no replacement component to perform the function of the failed component, the step of determining the operation mode of the RSPA controller may include a step of determining the operation mode of the RSPA controller and the operation mode of the cooperative controller based on whether the RSPA controller may perform the fail-safe function when the RSPA controller may not be operated with limited functions. When the RSPA controller is operable with limited functions, the operation mode of the RSPA controller may be determined such that the RSPA controller is operated with limited functions. The apparatus for performing the fail-safe function may operate the RSPA controller or the cooperative controller based on the operation mode (S830). Whether the RSPA controller performs the fail-safe function and whether the cooperative controller performs the fail-safe function may be determined based on a failure severity of the vehicle.

In view of the above, embodiments of the present disclosure provide a method and apparatus which can perform a fail-safe function according to the severity of failure when failure occurs in a safety-related component of a vehicle.

Further, embodiments of the present disclosure provide a method and apparatus which can perform a fail-safe function using an RSPA controller when failure occurs in a safety-related component of a vehicle.

Further, embodiments of the present disclosure provide a method and apparatus which can perform a fail-safe function using a cooperative controller when failure occurs in a safety-related component of a vehicle.

Further, embodiments of the present disclosure provide a method and apparatus which can enhance the stability of an RSPA and increase a driver's convenience.

The objectives achievable by embodiments of the present disclosure are not limited to the above-mentioned objectives, and other objectives which are not mentioned will be clearly understood by those skilled in the art from the foregoing description.

Each element of the apparatus or method in accordance with embodiments of the present invention may be implemented in hardware, software or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for performing a fail-safe function using an apparatus for performing the fail-safe function, the method comprising:
determining whether there is a replacement component to perform a function of a failed component in response to failure of one or more components installed in a vehicle;
determining an operation mode of a remote smart parking assist (RSPA) controller based on a result of determining whether there is the replacement component; and
operating the RSPA controller or a cooperative controller based on the operation mode.

2. The method of claim 1, wherein the one or more components installed in the vehicle comprise at least one component selected from the group consisting of the RSPA controller, a braking device, a steering device, communication device, an ultrasonic device, an imaging device, a lidar, a driving device, a transmission device, and a remote device.

3. The method of claim 1, wherein, in a state in which the RSPA controller is not operated yet and there is no replacement component to perform the function of the failed component, determining the operation mode of the RSPA controller comprises
determining the operation mode of the RSPA controller based on whether the RSPA controller is operable with limited functions.

4. The method of claim 1, wherein, in a state in which the RSPA controller is not operated yet and the replacement component is present to perform the function of the failed component, determining the operation mode of the RSPA controller comprises:
determining whether the vehicle may be stopped in a case in which the replacement component fails; and
determining the operation mode of the RSPA controller based on a result of determining whether the vehicle may be stopped.

5. The method of claim 1, wherein:
in a state in which a driver is in the vehicle, the RSPA controller is in operation, and there is no replacement component to perform the function of the failed component, determining the operation mode of the RSPA controller comprises
determining the operation mode of the RSPA controller based on whether the RSPA controller is operable with limited functions; and
in a state in which the RSPA controller is in operation and the replacement component is present to perform the function of the failed component, the operation mode of the RSPA controller is determined such that the RSPA controller controls the replacement component.

6. The method of claim 5, wherein:
in a state in which the RSPA controller is not operable with limited functions, determining the operation mode of the RSPA controller comprises
determining the operation mode of the RSPA controller and the operation mode of the cooperative controller based on whether the RSPA controller may perform the fail-safe function; and
in a state in which the RSPA controller is operable with the limited functions, the operation mode of the RSPA controller is determined such that the RSPA controller is operated with the limited functions.

7. The method of claim 1, wherein, in a state in which a driver is not in the vehicle, the RSPA controller is in operation, and the replacement component is present to perform the function of the failed component, determining the operation mode of the RSPA controller comprises:
determining whether the vehicle may be stopped in a case in which the replacement component fails; and
determining the operation mode of the RSPA controller based on a result of determining whether the vehicle may be stopped.

8. The method of claim 1, wherein, in a state in which a driver is not in the vehicle, the RSPA controller is in operation, and there is no replacement component to perform the function of the failed component, determining the operation mode of the RSPA controller comprises:
determining the operation mode of the RSPA controller and the operation mode of the cooperative controller based on whether the RSPA controller may perform the fail-safe function in a case in which the RSPA controller is not operable with limited functions; and
in a state in which the RSPA controller is operable with the limited functions, the operation mode of the RSPA controller is determined such that the RSPA controller is operated with the limited functions.

9. The method of claim 1, wherein the cooperative controller comprises at least one controller selected from the group consisting of a braking controller, a steering controller, a communication controller, a driving controller, a transmission controller, and a remote controller.

10. The method of claim 1, wherein whether the RSPA controller performs the fail-safe function and whether the cooperative controller performs the fail-safe function are determined based on a failure severity of the vehicle.

11. An apparatus for performing a fail-safe function, the apparatus comprising:
one or more processors; and
a storage device storing a program to be executed by the one or more processors, the program including instructions for:
determining whether there is a replacement component to perform a function of a failed component in response to failure of one or more components installed in a vehicle;
determining an operation mode of a remote smart parking assist (RSPA) controller based on a result of determining whether there is the replacement component; and
operating the RSPA controller or a cooperative controller based on the operation mode.

12. The apparatus of claim 11, wherein the one or more components installed in the vehicle comprise at least one component selected from the group consisting of the RSPA controller, a braking device, a steering device, a communication device, an ultrasonic device, an imaging device, a lidar, a driving device, a transmission device, and a remote device.

13. The apparatus of claim 11, wherein, in a state in which the RSPA controller is not operated yet and there is no replacement component to perform the function of the failed component,
the program includes instructions for determining the operation mode of the RSPA controller based on whether the RSPA controller is operable with limited functions.

14. The apparatus of claim 11, wherein, in a state in which the RSPA controller is not operated yet and the replacement component is present to perform the function of the failed component, the program includes instructions for:
determining whether the vehicle may be stopped in a case in which the replacement component fails; and
determining the operation mode of the RSPA controller based on a result of determining whether the vehicle may be stopped.

15. The apparatus of claim 11, wherein:
in a state in which a driver is in the vehicle, the RSPA controller is in operation, and there is no replacement component to perform the function of the failed component, the program includes instructions for
determining the operation mode of the RSPA controller based on whether the RSPA controller is operable with limited functions; and
in a state in which the RSPA controller is in operation and the replacement component is present to perform the function of the failed component, the operation mode of the RSPA controller is determined such that the RSPA controller controls the replacement component.

16. The apparatus of claim 15, wherein:
in a state in which the RSPA controller is not operable with the limited functions, the program includes instructions for
determining the operation mode of the RSPA controller and the operation mode of the cooperative controller based on whether the RSPA controller may perform the fail-safe function; and
in a state in which the RSPA controller is operable with the limited functions, the operation mode of the RSPA controller is determined such that the RSPA controller is operated with the limited functions.

17. The apparatus of claim 11, wherein, in a state in which a driver is not in the vehicle, the RSPA controller is in operation, and the replacement component is present to perform the function of the failed component, the program includes instructions for:
determining whether the vehicle may be stopped in a case in which the replacement component fails; and
determining the operation mode of the RSPA controller based on a result of determining whether the vehicle may be stopped.

18. The apparatus of claim 11, wherein:
in a state in which a driver is not in the vehicle, the RSPA controller is in operation, and there is no replacement component to perform the function of the failed component, the program includes instructions for
determining the operation mode of the RSPA controller and the operation mode of the cooperative controller based on whether the RSPA controller may perform the fail-safe function in a state in which the RSPA controller is not operable with limited functions; and
in a state in which the RSPA controller is operable with the limited functions, the operation mode of the RSPA controller is determined such that the RSPA controller is operated with limited functions.

19. The apparatus of claim 11, wherein the cooperative controller comprises at least one controller selected from the group consisting of a braking controller, a steering controller, a communication controller, a driving controller, a transmission controller, and a remote controller.

20. The apparatus of claim 11, wherein a determination of whether the RSPA controller performs the fail-safe function and a determination of whether the cooperative controller performs the fail-safe function are based on a failure severity of the vehicle.
